(19) United States
(12) Patent Application Publication
(10) Pub. No.: US 2004/0097205 A1
(43) Pub. Date: May 20, 2004

(54) Method and apparatus for automatic gain control of radio frequency communication system

(75) Inventor: Do Hoon Kim, Anyang (KR)

Correspondence Address: FLESHNER & KIM, LLP, P.O. BOX 221200, CHANTILLY, VA, 20153, US

(73) Assignee: LG Electronics Inc.

(21) Appl. No.: 10/691,615

(22) Filed: Oct. 24, 2003

(30) Foreign Application Priority Data
Nov. 14, 2002 (KR) 70891/2002

(51) Int. Cl. H04B 17/02; H04B 1/06; H04B 7/00

(52) U.S. Cl. 455/136; 455/138; 455/232.1

(57) ABSTRACT

A method and an apparatus for automating gain control of a radio frequency communication system can adapt a radio frequency communication system to an environment where a radio channel characteristic is rapidly or slowly changed. This can be achieved by extracting a maximum absolute value of a reception signal received by a receiver of a radio frequency communication system, determining a gain control value of the reception signal on the basis of the maximum absolute value and a predetermined threshold, and controlling gain of the reception signal according to the determined gain control value.

### BACKGROUND OF THE INVENTION

1. Field of the Invention

The present invention relates to a radio frequency communication system, and particularly to a method and an apparatus for automatic gain control of a radio frequency communication system.

2. Description of the Related Art

In general, a radio frequency communication system includes a radio frequency receiving block and a baseband digital signal processing block or a baseband modem block. For the radio frequency communication system, radio frequency converting techniques of two different types, a direct frequency conversion and a super heterodyne are used.

A receiver of a radio frequency communication system to which a direct frequency conversion method according to the conventional art is applied, directly converts a radio reception signal (carrier signal) into a baseband frequency, using only a single PLL circuit (phase locked loop circuit).

Hereinafter, a configuration of a double super-heterodyne receiver of the radio frequency communication system will now be described with reference to FIG. 1.

FIG. 1 is a block diagram showing a configuration of a double super-heterodyne receiver of a radio frequency communication system according to the conventional art. That is, FIG. 1 illustrates a configuration of a receiver of a radio frequency communication system to which a double super-heterodyne method for converting a radio reception signal transmitted through a frequency channel into a intermediate frequency (IF), and then, with using a PLL circuit (phase locked loop circuit) for selecting a tuning channel, converting the intermediate frequency (IF) into a baseband frequency, is applied.

The configuration of a double super-heterodyne receiver is used for a radio frequency receiver to demodulate a signal altered into a QPSK (quadrature phase shift keying) type or a QAM (quadrature amplitude modulation) type. The configuration of a double super-heterodyne receiver of the radio frequency communication system is described in detail in U.S. Pat. No. 4,225,922 and U.S. Pat. No. 6,397,048, so detailed description thereof will be omitted.

Hereinafter, operations and configurations of an automatic gain control apparatus, which is applied to the radio frequency communication system to control gain of a reception signal, will now be described with reference to FIG. 2.

FIG. 2 is a block diagram showing a configuration of an automatic gain control apparatus applied to a radio frequency communication system according to the conventional art.

As shown therein, an automatic gain control apparatus includes a multiplier 11 controlling gain of a reception signal of an intermediate frequency band (IF Rx) which has passed through a front-end of a receiver of the radio frequency communication system; an amplitude controller 14 squaring the signal whose gain has been controlled by the multiplier 11, calculating a power value of the squared signal, and outputting the calculated power value; a controller 15 calculating a gain control value of the power value calculated by the amplitude controller 14, and outputting the gain control value; and a delay circuit 12 delaying the gain control value outputted from the controller 15, and transmitting the delayed gain control value to the multiplier 11. Herein, the delay circuit 12 transmits the delayed gain control value to the multiplier 11, and feeds back the delayed gain control value to the controller 15. Hereinafter, the operations of the auto gain control apparatus will now be described.

First, the multiplier 11 controls gain of a reception signal of an intermediate frequency band (IF Rx) which has passed through a front-end of a receiver of the radio frequency band, and transmits the gain-controlled signal to an I/Q demodulator 13 and the amplitude controller 14.

The I/Q demodulator 13 demodulates the gain-controlled signal, and transmits the demodulated signal to a baseband modem (not shown).

The amplitude controller 14 squares the signal whose gain has been controlled by the multiplier 11, calculates a power value of the squared signal, and outputs the calculated power value to the controller 15.

The controller 15 calculates a gain control value of the power value calculated by the amplitude controller 14, and outputs the gain control value to the delay circuit 12.

The delay circuit 12 delays the gain control value outputted from the controller 15, and transmits the delayed gain control value to the multiplier 11. Also, the delay circuit 12 feeds back the delayed gain control value to the controller 15. Herein, the multiplier 11 controls gain of the reception signal based on the gain control value transmitted from the delay circuit 12, and transmits the gain-controlled signal to the I/O demodulator 13 and the amplitude controller 14.

However, in the auto gain control apparatus of the radio frequency communication system according to the conventional art, in outputting the gain control value delayed through the delay circuit 12 to the multiplier 11, if an ill-predicted gain control value is outputted to the multiplier 11, a reception signal whose gain is controlled by the gain control value is distorted.

Also, in the radio frequency communication system according to the conventional art, since the number of variation times of the gain control value of the auto gain control apparatus is fixed, the system cannot adapt to an environment where a radio channel characteristic is rapidly or slowly changed.

### SUMMARY OF THE INVENTION

Therefore, an object of the present invention is to provide a method and an apparatus for gain control of a radio frequency communication system capable of adapting to a environment where a radio channel characteristic is rapidly or slowly changed, by extracting a maximum absolute value of a reception signal, determining a gain control value by comparing the extracted maximum absolute value and a threshold, and controlling gain of the reception signal on the basis of the determined gain control value.

Another object of the present invention is to provide a method and an apparatus for gain control of a radio frequency communication system capable of preventing distortion of a reception signal whose gain has been controlled by a gain control value, by extracting a maximum absolute value of a reception signal, determining a gain control value by comparing the extracted maximum absolute value and a threshold, and controlling gain of the reception signal on the basis of the determined gain control value.

To achieve these and other advantages and in accordance with the purpose of the present invention, as embodied and broadly described herein, there is provided a gain control method of a radio frequency communication system according to the present invention including the steps of: extracting a maximum absolute value of a reception signal received by a receiver of a radio frequency communication system, determining a gain control value of the reception signal on the basis of the maximum absolute value and a predetermined threshold, and controlling gain of the reception signal according to the determined gain control value.

To achieve these and other advantages and in accordance with the purpose of the present invention, as embodied and broadly described herein, there is provided a gain control apparatus of a radio frequency communication system including means for: extracting a maximum absolute value of a reception signal received by a receiver of a radio frequency communication system, determining a gain control value of the reception signal on the basis of the maximum absolute value and a predetermined threshold, and controlling gain of the reception signal according to the determined gain control value.

To achieve these and other advantages and in accordance with the purpose of the present invention, as embodied and broadly described herein, there is provided a gain control apparatus of a radio frequency communication system including an amplitude controller for calculating absolute values of a reception signal received by a receiver of a radio frequency communication system; a buffer for storing the absolute values of the reception signal, which have been calculated by the amplitude controller; a controller for extracting a maximum absolute value among the absolute values stored at the buffer, and determining a gain control value of the reception signal by comparing the extracted maximum absolute value with a predetermined threshold; and a multiplier for amplifying the reception signal by multiplying the reception signal by the determined gain control value, and outputting the amplified reception signal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a block diagram showing a configuration of a double super-heterodyne receiver of a radio frequency communication system according to the conventional art;

FIG. 2 is a block diagram showing a configuration of an automatic gain control apparatus applied to a radio frequency communication system according to the conventional art;

FIG. 3 is a block diagram showing a configuration of an automatic gain control apparatus of a radio frequency communication system according to the present invention; and

FIG. 4 is an exemplary view showing an absolute value of a reception signal of FIG. 3.

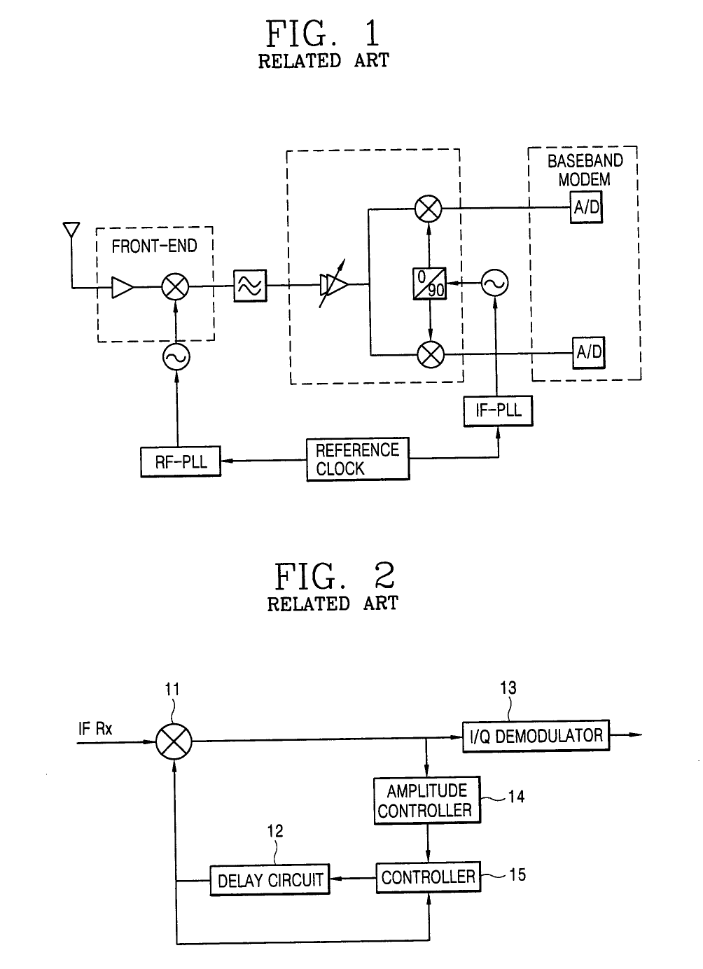

### DETAILED DESCRIPTION OF THE PREFERRED EMBODIMENTS

Reference will now be made in detail to the preferred embodiments of the present invention, examples of which are illustrated in the accompanying drawings.

Hereinafter, a preferred embodiment of an gain control apparatus of a radio frequency communication system capable of adapting to an environment where a radio channel characteristic is rapidly or slowly changed, by determining a gain control value for controlling gain of a reception signal on the basis of a maximum absolute value of a reception signal received by a receiver of a radio frequency communication system and a predetermined threshold, and controlling gain of the reception signal according to the determined gain control value.

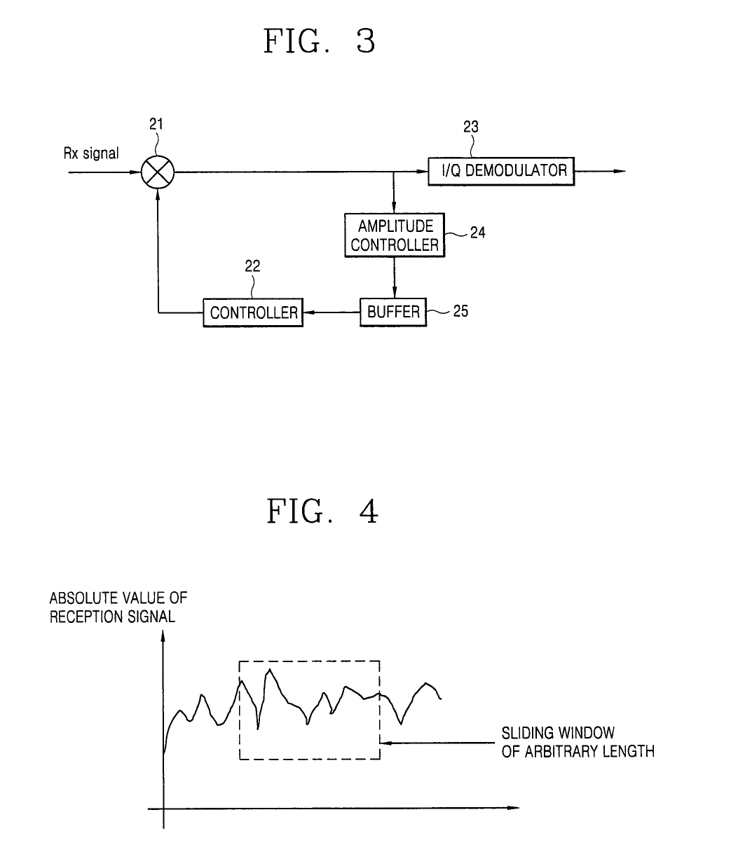

FIG. 3 is a block diagram showing a configuration of an automatic gain control apparatus of a radio frequency communication system according to the present invention.

As shown FIG. 3, the automatic gain control apparatus includes a multiplier 21 for controlling gain of a reception signal (Rx signal) received by a receiver of the radio frequency communication system; an amplitude controller 24 for calculating an absolute value of a signal whose gain has been controlled by the multiplier 21, and outputting the calculated absolute value; a buffer 25 for storing absolute values of the reception signal (gain-controlled signal) outputted from the amplitude controller 24; and a controller 22 for extracting a maximum absolute value among the absolute values of the reception signal stored at the buffer 25, determining a gain control gain of the reception signal by comparing the extracted maximum absolute value and a predetermined threshold, and outputting the determined gain control value to the multiplier 21. Herein, the multiplier 21 amplifies the reception signal by multiplying the reception signal by the gain control value outputted from the controller 22, and outputs the amplified reception signal (gain-controlled signal) to an I/Q demodulator 23.

Hereinafter, operations of an auto gain control apparatus of the radio frequency communication system will now be described in detail with reference to FIG. 4.

FIG. 4 is an exemplary view showing absolute values of a reception signal (Rx) of FIG. 3. Herein, absolute values of a reception signal (Rx), which are changed according to time, is stored at the buffer 25, and the buffer 25 outputs a maximum absolute value among the stored absolute values of the reception signal.

First, the multiplier 21 controls gain of a Rx signal of an intermediate frequency band which has passed through a front-end of a receiver of the radio frequency communication system, and transmits the gain-controlled signal to the I/Q demodulator 23 and the amplitude controller 24.

The I/Q demodulator 23 demodulates the gain-controlled signal, and transmits the demodulated signal to a baseband modem (not shown).

The amplitude controller 24 calculates an absolute value of the signal whose gain has been controlled by the multiplier 21, and outputs the calculated absolute value to the buffer 25. At this time, the buffer 25 stores absolute values of a reception signal, which have been calculated by the amplitude controller 24. In addition, the buffer 25, a first-in first-out storage, is limited at a certain length, so if signals same as or more than the certain number come into the buffer 25, data which have come into and have stored at the buffer 25 at a very beginning, are deleted. Herein, the absolute value of the reception signal means an amplitude value of a reception signal.

Thereafter, the controller 22 extracts a maximum absolute value among the stored absolute values of the reception signal, and determines a gain control value by comparing the extracted maximum absolute value with a predetermined threshold. Herein, the gain control value is for amplifying the reception signal to make the maximum absolute value consist with the threshold when the maximum absolute value is smaller than the threshold. Also, the threshold means a maximum absolute value of a predetermined reception signal.

Thereafter, the multiplier 21 amplifies a reception signal (Rx signal) by multiplying the reception signal (Rx signal), which has received by a receiver of the radio frequency communication system, by the gain control value, and outputs the amplified reception signal to the I/Q demodulator 23. At this time, the I/Q demodulator 23 demodulates the amplified reception signal (gain-controlled signal), and transmits the demodulated signal to a baseband modem (not shown).

In the present invention, since the gain control value can be updated from time to time, a user can control the number of updates according to a structure of a communication system. Also, the present invention can be applied to both super-heterodyne method demodulating data via an intermediate frequency band and direct frequency conversion method which is not passed through an intermediate frequency band.

As so far described, the automatic gain control apparatus according to the present invention extracts a maximum absolute value of a reception signal, determines a gain control value of the reception signal by comparing the extracted maximum absolute value and a threshold, and controls gain of the reception signal on the basis of the determined gain control value, so that a radio frequency communication system (e.g. portable terminal) can adapt to an environment where a radio channel characteristic is rapidly or slowly changed.

In addition, the automatic gain control apparatus according to the present invention extracts a maximum absolute value of a reception signal, determines a gain control value of the reception signal by comparing the extracted maximum absolute value and a threshold, and controls gain of the reception signal on the basis of the determined gain control value, so that distortion of a reception signal whose gain has been controlled by the gain control value, can be prevented.

In addition, since, the automatic gain control apparatus according to the present invention has a simple configuration, can readily adapt to change of a radio channel characteristic, performance of a radio frequency communication system (e.g. portable terminal) can be improved in general.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An automatic gain control method comprising:
extracting a maximum absolute value of a reception signal received by a receiver of a radio frequency communication system;
determining a gain control value of the reception signal on the basis of the maximum absolute value and a predetermined threshold; and
controlling gain of the reception signal according to the determined gain control value.

2. The method of claim 1, wherein the step of abstracting the maximum absolute value comprises:
storing absolute values of the reception signal; and
extracting the maximum absolute value among the stored absolute values.

3. The method of claim 1, wherein the step of controlling the gain comprises:
amplifying the reception signal by multiplying the reception signal by the determined gain control value; and
outputting the amplified reception signal.

4. The method of claim 1, wherein the gain control value is for amplifying the reception signal to make the extracted maximum absolute value consist with the predetermined threshold, and the predetermined threshold is a maximum absolute value of a predetermined reception signal.

5. An automatic gain control apparatus of a radio frequency communication system comprises the means for:
extracting a maximum absolute value of a reception signal received by a receiver of a radio frequency communication system;
determining a gain control value of the reception signal on the basis of the maximum absolute value and a predetermined threshold; and
controlling gain of the reception signal according to the determined gain control value.

6. The apparatus of claim 5, further comprising a means for storing absolute values of the reception signal.

7. The apparatus of claim 6, wherein the means for extracting the maximum absolute value extracts the maximum absolute value among the stored absolute values.

8. The apparatus of claim 5, wherein the means for controlling the gain amplifies the reception signal by multiplying the reception signal by the determined gain control value, and outputs the amplified reception signal.

9. The apparatus of claim 5, wherein the means for determining a gain control value of the reception signal determines a gain control value for amplifying the reception signal to make the abstracted maximum absolute value consist with the predetermined threshold, wherein the threshold is a maximum absolute value of a predetermined reception signal.

10. An automatic gain control apparatus of a radio frequency communication system comprises:
an amplitude controller for calculating absolute values of a reception signal received by a receiver of a radio frequency communication system;
a buffer for storing the absolute values of the reception signal, which have been calculated by the amplitude controller;
a controller for extracting a maximum absolute value among the absolute values stored at the buffer, and determining a gain control value of the reception signal by comparing the extracted maximum absolute value with a predetermined threshold; and
a multiplier for amplifying the reception signal by multiplying the reception signal by the determined gain control value, and outputting the amplified reception signal.

11. The apparatus of claim 10, wherein the buffer is a first-in first-out storage.

12. The apparatus of claim 10, wherein the gain control value is for amplifying the reception signal to make the extracted maximum absolute value consist with the predetermined threshold, and the predetermined threshold is a maximum value of a predetermined reception signal.
